(19) United States
(12) Patent Application Publication
(10) Pub. No.: US 2015/0059953 A1
(43) Pub. Date: Mar. 5, 2015

(54) METHOD OF ASSEMBLY OF AIR MAINTENANCE TIRE SYSTEM

(71) Applicant: The Goodyear Tire & Rubber Company, Akron, OH (US)

(72) Inventors: Carolin Anna Welter, Schleich (DE); Dinesh Chandra, Stow, OH (US); Robert Leon Benedict, Tallmadge, OH (US); Arun Kumar Byatarayanapura Gopala, Copley, OH (US)

(21) Appl. No.: 14/454,098

(22) Filed: Aug. 7, 2014

Related U.S. Application Data
(60) Provisional application No. 61/872,399, filed on Aug. 30, 2013.

(51) Int. Cl. B60C 23/12; B29D 30/06

(52) U.S. Cl. CPC B60C 23/12; B29D 30/0681; B29D 30/0601
USPC 152/450; 156/110.1

(57) ABSTRACT

A tire assembly is disclosed, wherein the tire has a tread portion and a pair of sidewalls extending radially inward from the tread portion to join with a respective bead; a supporting carcass for the tread portion and sidewalls; and a pump passageway positioned within a bending region of the tire. The pump passageway is operative to open and close as the tire rotates. The tire assembly further includes a valve assembly in fluid communication with the pump passageway. The tire further includes a pocket formed in the tire, and a filter assembly is mounted in the pocket. The filter assembly is in air flow communication with the valve assembly, wherein the filter assembly is formed of a housing and a cover, wherein the cover has one or more holes for communicating air into the housing, wherein the cover is connected to the housing, the housing having an interior cavity having a filter media housed therein, the housing having a hole in fluid communication with the valve assembly, wherein a flexible collar surrounds the cover.

### FIELD OF THE INVENTION

The invention relates generally to tires and more specifically, to an air maintenance assembly for a tire.

### BACKGROUND OF THE INVENTION

Normal air diffusion reduces tire pressure over time. The natural state of tires is under inflated. Accordingly, drivers must repeatedly act to maintain tire pressures or they will see reduced fuel economy, tire life and reduced vehicle braking and handling performance. Tire Pressure Monitoring Systems have been proposed to warn drivers when tire pressure is significantly low. Such systems, however, remain dependent upon the driver taking remedial action when warned to re-inflate a tire to recommended pressure. It is a desirable, therefore, to incorporate an air maintenance feature within a tire that will maintain correct air pressure within the tire without a need for driver intervention to compensate for any reduction in tire pressure over time. It is useful to incorporate a filter in the design of an air maintenance tire system, so that the outside air is filtered. It is also useful to incorporate a regulator in the design to admit air into the system only when needed. The filter and regulator must be secured to the tire, and be able to sustain rotational forces. These devices must also be assembled in such a way to minimize the stresses in the tire and allow for ease of assembly.

### SUMMARY OF THE INVENTION

The invention provides in a first aspect an air maintenance tire and pump assembly including a tire having two spaced inextensible beads; a ground contacting tread portion; a pair of individual sidewalls extending radially inward from the axial outer edges of said tread portion to join the respective beads; a supporting carcass for the tread portion and sidewalls; an innerliner disposed radially inward of the carcass, the innerliner having a innerliner surface facing an interior cavity of the tire. A pump passageway is enclosed within a bending region of the tire, the pump passageway operatively closing and opening segment by segment as the bending region of the tire passes through a rolling tire footprint to pump air along the air passageway. A regulator device is in fluid communication with the pump passageway, the regulator device operable to regulate the fluid from outside of the tire into the pump passageway, the air inlet port assembly comprising a regulator assembly, the regulator device having a mounting surface coated with rubber. The mounting surface is adhered to the innerliner surface with a suitable adhesive.

The invention provides in a second aspect a method for making an air maintenance tire and pump assembly. First, a green tire is provided, wherein a pocket is molded in the sidewall of the tire, wherein the pocket has a hole extending though the side of the tire into the tire cavity. A groove is also molded in the sidewall of the tire, and then the tire is cured. A green rubber patch is then coated on both sides with rubber cement and inserted into the pocket. Next a filter housing is affixed to the green rubber patch and then cured. Next filter media is inserted into the filter housing and then a cover is secured to the filter housing.

### BRIEF DESCRIPTION OF THE DRAWINGS

The invention will be described by way of example and with reference to the accompanying drawings in which:

FIG. 1 is a front view of tire and rim assembly with a pump, valve and filter assembly.

FIG. 2 is a cross sectional view of a truck tire having a groove in the bead area of the tire;

FIG. 3 is a close up cross-sectional view of the truck tire bead area of FIG. 2 illustrating the pump passageway;

FIG. 4 is a close up cross-sectional view of the truck tire bead area illustrating a filter pocket;

FIG. 5 is a front view of a filter pocket shown in the bead area of the tire;

FIG. 6 is an exploded view of a filter assembly and tire bead area;

FIG. 7 is a cross-sectional view of the portion of the tire illustrating the filter assembly in the pocket of the tire bead area;

FIG. 8 is a front view of the filter assembly installed in the tire;

FIG. 9 is a front perspective view of the filter assembly;

FIG. 10 is a side cross-sectional view of the filter assembly.

FIG. 11 is a perspective view of the filter housing.

FIG. 12 is a cut away view of the filter housing.

FIGS. 13-15 are perspective views of a second embodiment of a filter housing.

FIG. 16 is a partial view of a tire mold showing the pocket mold mounted in the mold ring of the tire mold; and

FIG. 17 is a perspective view of the pocket mold subassembly.

### DETAILED DESCRIPTION OF THE INVENTION

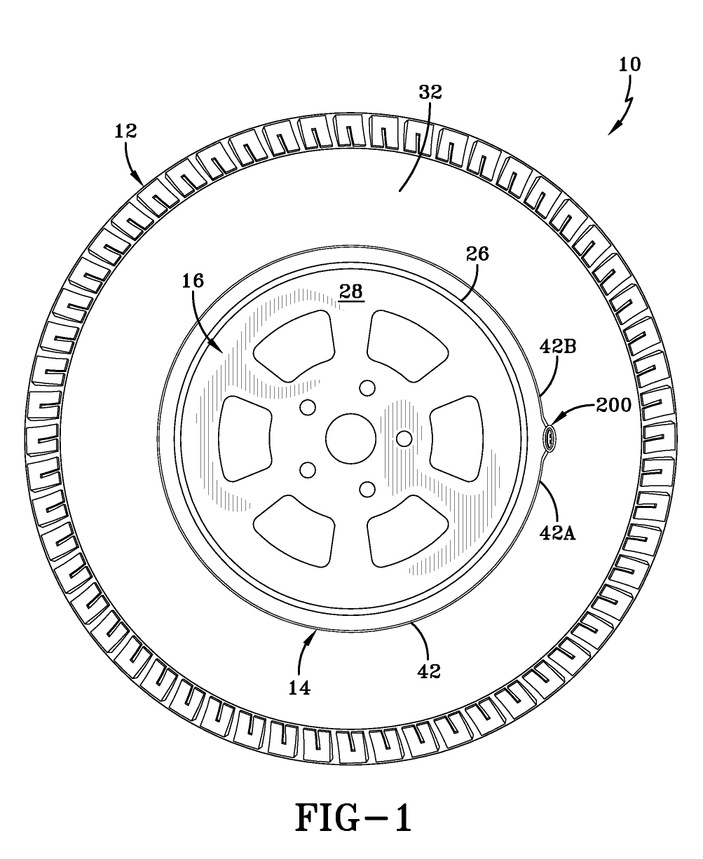

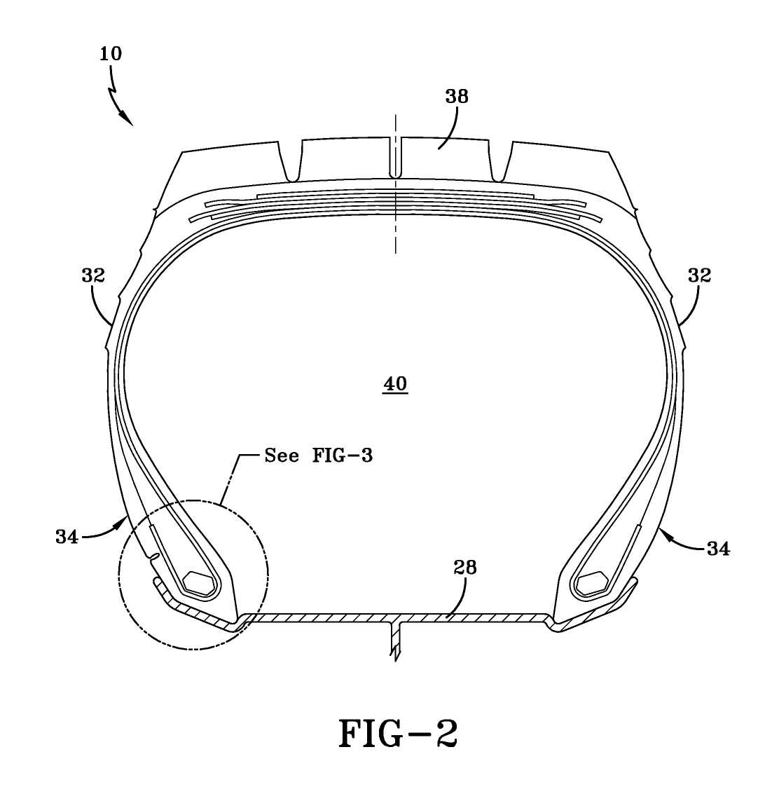

Referring to FIGS. 1 and 2, a tire assembly 10 includes a tire 12, a pump assembly 14, and a tire wheel 16. The tire mounts in a conventional fashion to a wheel having rim mounting surfaces 18 located adjacent outer rim flanges 22. An annular rim body 28 joins the rim flanges 22 and supports the tire assembly as shown. The tire is of conventional construction, having a pair of sidewalls 32 extending from opposite bead areas 34 to a crown or tire tread region 38. The tire and rim enclose an interior tire cavity 40 which is filled with air.

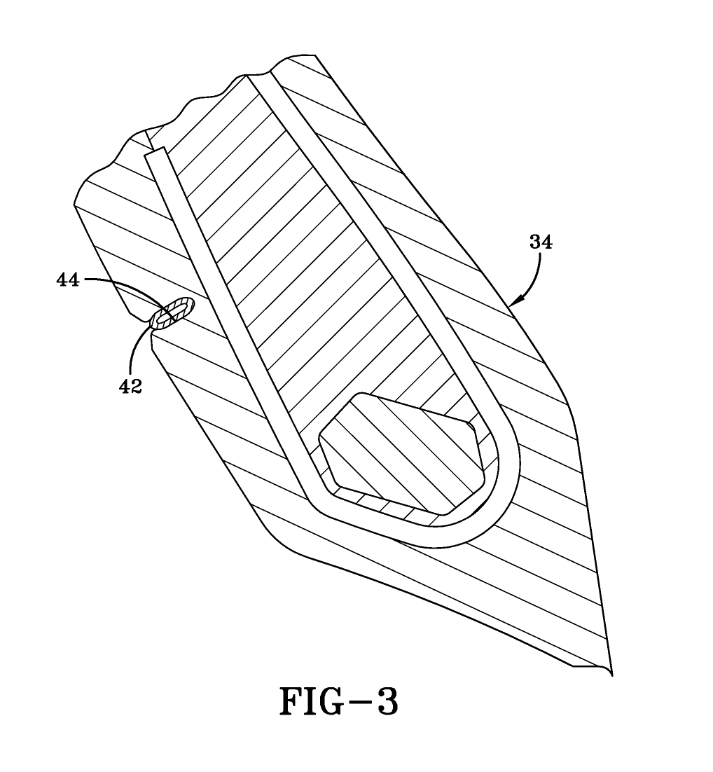

As shown in FIGS. 1 and 3, the tire assembly includes a pump 14 having a pump passageway 42 that is mounted or located in the tire in a channel 44, preferably near the bead region 34 of the sidewall. The pump passageway 42 may be formed of a discrete tube made of a resilient, flexible material such as plastic, elastomer or rubber compounds, and is capable of withstanding repeated deformation cycles when the tube is deformed into a flattened condition subject to external force and, upon removal of such force, returns to an original condition. The tube is of a diameter sufficient to operatively pass a volume of air sufficient for the purposes described herein and allowing a positioning of the tube in an operable location within the tire assembly as will be described. Preferably, the tube has an elliptical cross-sectional shape, although other shapes such as round may be utilized.

The pump passageway itself may also be integrally formed or molded into the sidewall of the tire during vulcanization, eliminating the need for an inserted tube. An integrally formed pump passageway is preferably made by building into a selected green tire component such as a chafer, a removable strip made of wire or silicone. The component is built into the tire and cured. The removable strip is then removed post cure to form a molded in or integrally formed pump air passageway.

Hereinafter, the term “pump passageway” refers either to installed tubes or an integrally molded in passageway. The location selected for the pump passageway within the tire may be within a tire component residing within a high flex region of the tire, sufficient to progressively collapse the internal hollow air passageway as the tire rotates under load thereby conveying air along the air passageway from the inlet to the pump outlet.

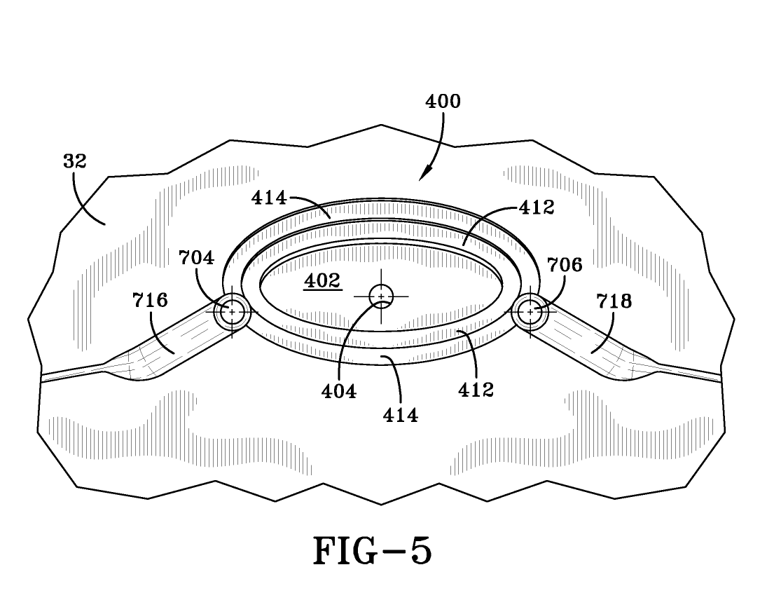

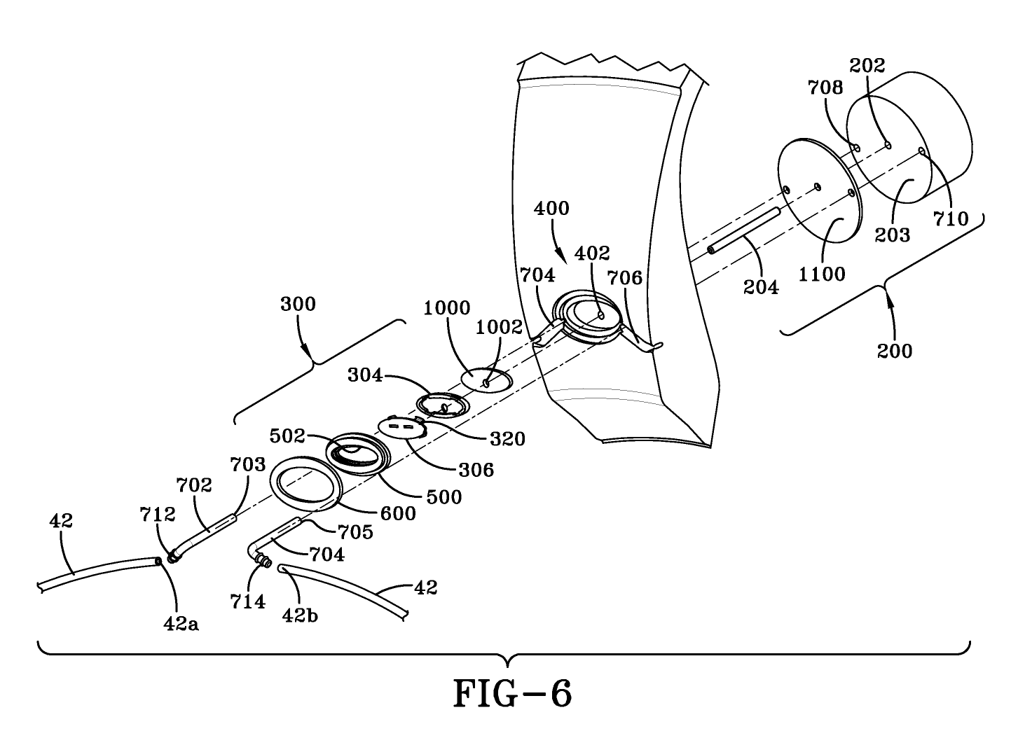

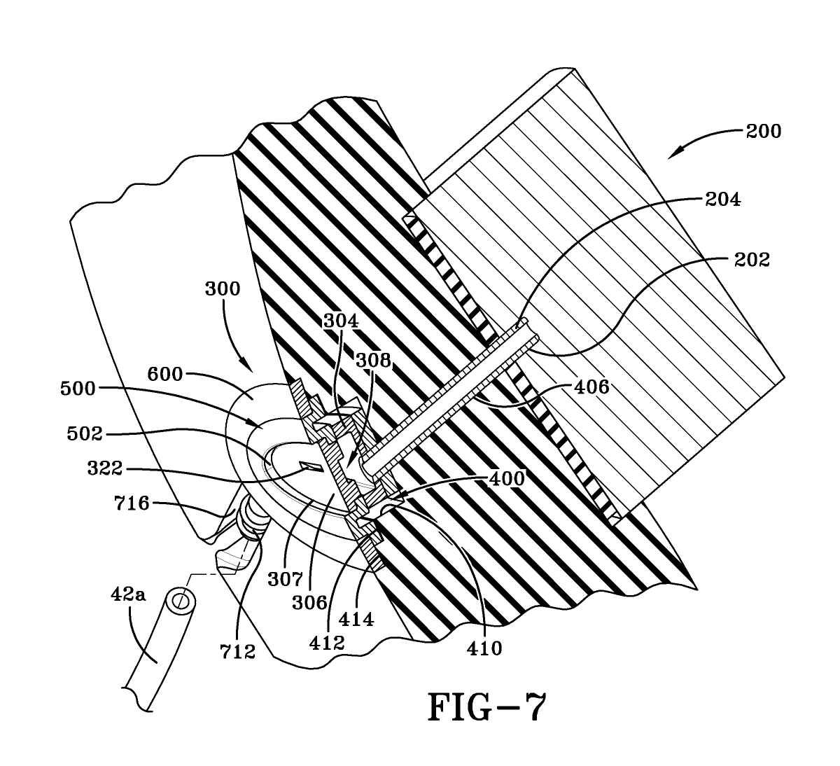

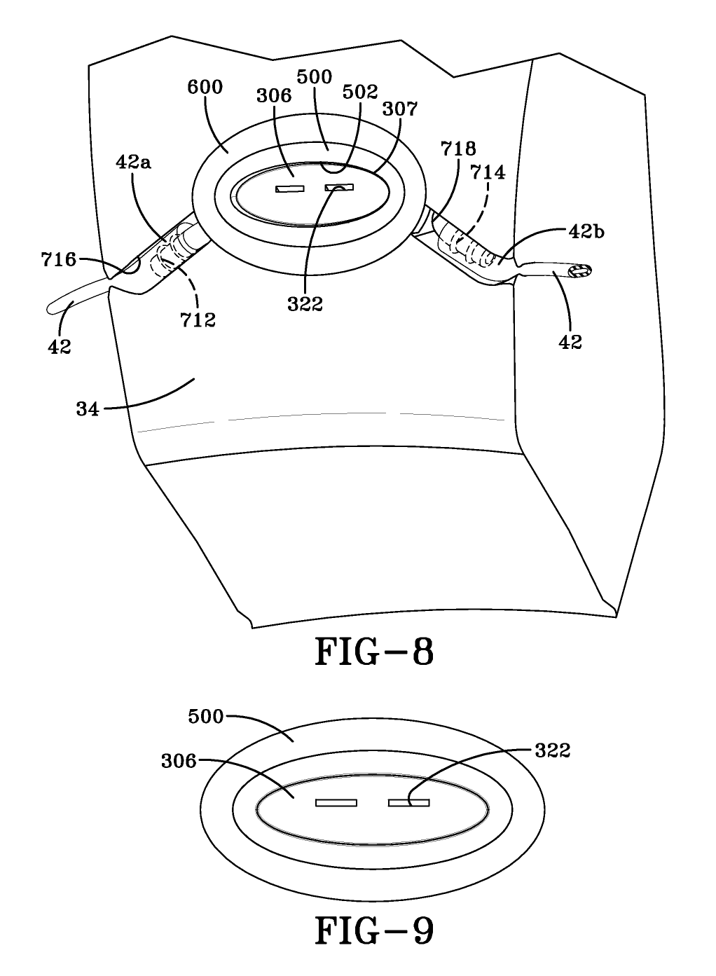

The pump air passageway 42 has an inlet end 42a and an outlet end 42b joined together by a valve system 200, as shown in FIGS. 6-7. Examples of pressure regulators or valve systems suitable for use with the invention are disclosed in U.S. patent application Ser. Nos. 13/221,231, 13/221,433, 13,221,506 which are hereby incorporated by reference. As shown in this particular example, the inlet end 42a and the outlet end 42b are spaced apart approximately 360 degrees forming an annular pump assembly. However, the inlet and outlet ends may be spaced apart 90 degrees, 180 degrees, etc.

The valve assembly 200 is preferably affixed to the inside of the tire, near the bead area. The valve assembly 200 has an inlet port 202 that is in fluid communication with a central air conduit 204. The central air conduit 204 is in fluid communication with an air filter assembly 300, as shown in FIGS. 6-8. The central air conduit is preferably a flexible tube or passageway that extends from a filter housing to the inlet port 202 of the valve assembly 200.

The valve assembly 200 is operable to control the amount of inlet air to the pump system 42. If the tire cavity pressure falls below a set trigger pressure, the valve device allows air to enter the valve assembly 200 through inlet port 202, and then through to the pump passageway 42. The valve assembly may allow airflow into the pump system through an air inlet port 210. The valve assembly also may control the flow of air from the pump into the tire cavity, as well as prevent cavity air from back flowing into the pump passageways.

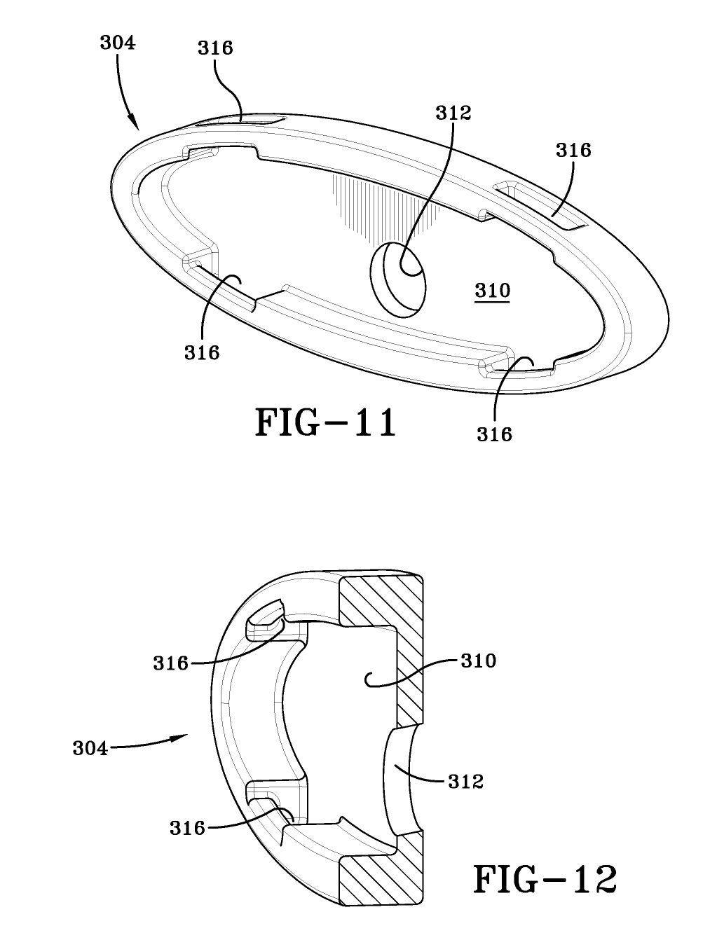

The air filter assembly 300 is positioned on the outer sidewall of the tire, in the vicinity of the pump passageways, as shown in FIGS. 6-8. The air filter assembly filters the outside air and communicates the filtered air to the inlet port 202 of the valve assembly 200. The air filter assembly 300 has a housing 304, and a cover 306 which assemble together to form an internal cavity 308. The filter housing 304 is shown in FIGS. 7, 10, 11, and 12. The filter housing 304 is also preferably elliptical in shape, with the minor axis aligned with the radial direction of the tire. The bottom surface 310 of the filter housing has a hole 312 for reception of a first end of the central air conduit 204. The filter housing has a sidewall 314 having cutouts 316. Tabular ends 320 of the cover 306 are received in the cutouts 316 to attach the cover to the filter housing. The front face of the cover has one or more holes 322. The filter housing 304 and cover 306 may be made of hard plastic or metal.

One or more layers of filter media 600 is received in the internal cavity 308 of the filter assembly 300. The filter media may be a woven or nonwoven fiber, foam, spun fiberglass, charcoal, or other materials known to those skilled the art. Alternatively, a membrane such as PTFE GoreTex may be used, alone or in combination with the filter media.

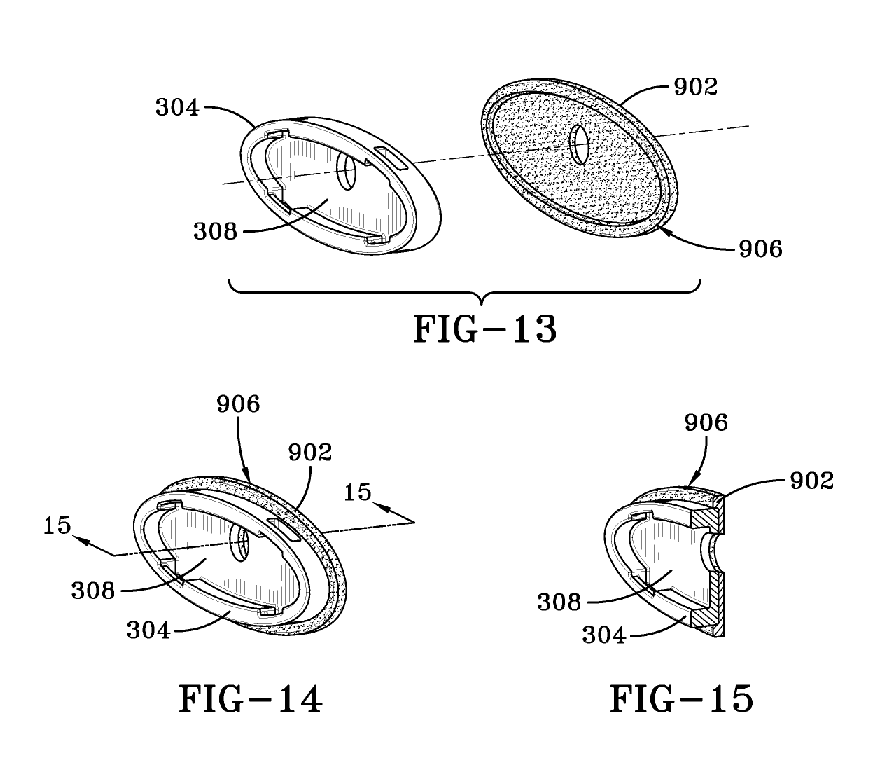

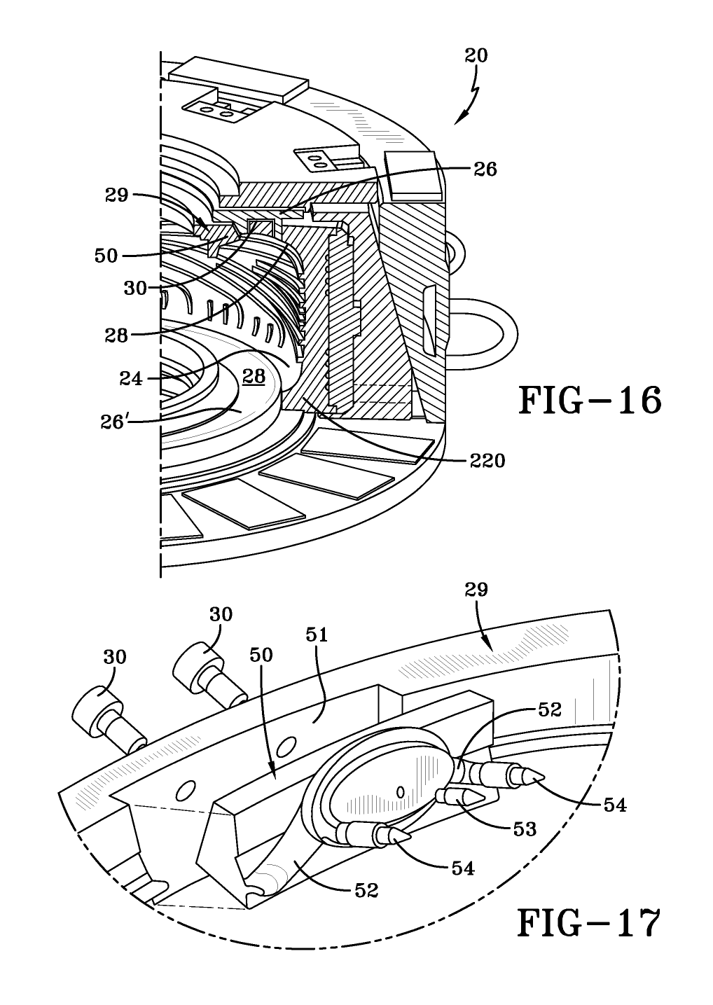

The air filter assembly 300 is mounted in a pocket 400 formed on the outer surface of the tire, typically in the sidewall area near the pump passageways. The pocket 400 is shown in FIGS. 4-6. The pocket may be molded in the tire during vulcanization using a conventional mold with an adaptor piece to form the pocket (not shown). The pocket may be molded in the tire during vulcanization as follows. FIG. 13 illustrates a typical mold 20 used for molding and vulcanizing a green tire. The mold assembly typically comprises a plurality of segments 220 which are arranged to form an annular ring to encircle the tread of a green tire when the segments are assembled together. The outer tread surface of a tire is formed by the inner molding surface 24 of the segments 220. A sidewall plate 26 is used to mold the sidewalls 32 of the tire. Adjacent the sidewall plate 26 is a mold ring 29 that molds the inner bead region of the tire. As shown in FIG. 14, a section of the mold ring 29 has a cutout portion 51 for receiving a pocket mold 50. The pocket mold 50 may be secured to the mold ring 29 via bolts 30. The pocket mold 50 forms the pocket 400 in the tire sidewall area. Alternatively, the sidewall plate 26 may also be used to install the pocket mold 52, depending on the desired location of the filter assembly. As shown in FIG. 14, the pocket mold 50 forms or molds an elliptically shaped pocket 400 into the tire sidewall bead area, and the barb 53 of the pocket mold forms the passageway 406 through the tire sidewall. The pocket mold has wings 52 located on either side of the pocket 400. The wings 52 form the slots 716,718 that are used to house the pump tubes 702,703. Barbs 54 on the pocket mold form holes 704,706 that extend completely through the tire sidewall.

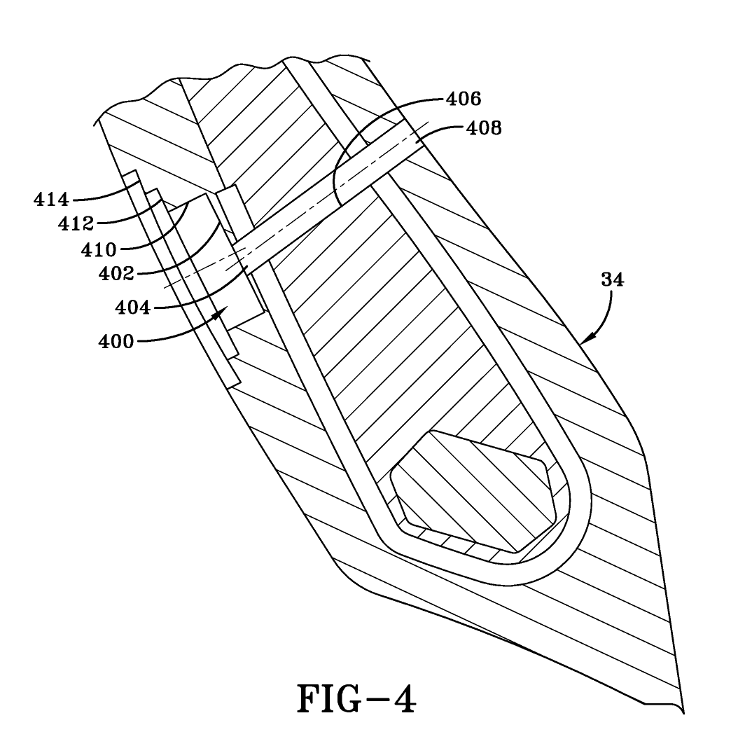

Alternatively, the pocket may be formed in a vulcanized tire, post cure by laser cutting. As shown in FIG. 5, the general shape of the pocket 400 is curved, with no corners to eliminate stress concentrations. It is preferred that the pocket is also elliptical in shape, with the minor axis of the ellipse aligned with the radial direction of the tire. The pocket may also be round. The depth of the pocket is about 5-15 mm, and the major axis width is about 20-40 mm, minor axis width is about 8-15 mm. The pocket has a bottom surface 402 having a hole 404 that is connected to a passageway 406 formed through the tire to the tire cavity, so that fluid may communicate from the hole 404 in the pocket to the passageway exit 408. An optional central air conduit 204 is positioned in the passageway 406 to communicate filtered air to the valve assembly 200. Alternatively, the passageway 406 may be used to communicate fluid to the cavity from the pocket.

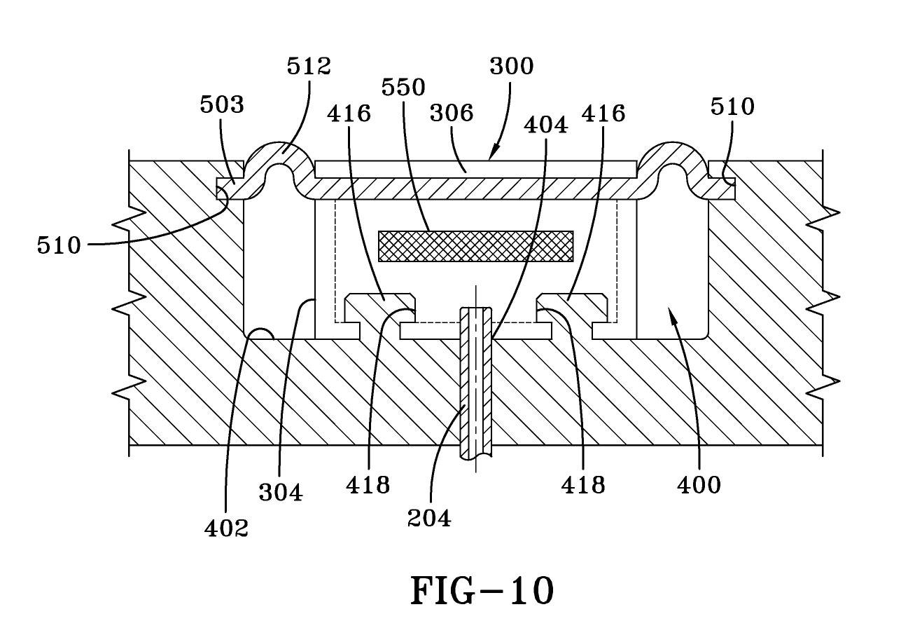

The bottom surface 402 of the pocket may further optionally include molded in attachment knobs 416 as shown in FIG. 10. The attachment knobs 416 may be used to secure a filter housing to the pocket. The bottom of the filter housing may have recesses 418 which allow the knobs 416 to snap inside, as shown in FIG. 10. Alternatively, the filter housing may have knobs (not shown) which are secured into recesses of the pocket (not shown).

The pocket 400 further includes a sidewall 410. The sidewall 410 is surrounded by a first and second ledge 412,414 joined together. A flexible collar 500 has an interior hole 502 wherein the interior hole is positioned around the outer circumferential edge 307 of the cover 306. The flexible collar 500 has a second end positioned on the first ledge 412. Alternatively, the second end may be positioned in a slot 510 formed in the sidewall of the pocket, as shown in FIG. 10. The cross-sectional profile 512 of the flexible collar may be U shaped. The flexible collar allows for the ±10% sidewall strain seen in tire service while protecting the filter media from flexing. The flexible collar 500 is made from a flexible material such as rubber.

A green (unvulcanized) rubber ring 600 has an inner hole that is positioned about the outer circumference of the flexible collar 500 and wherein the outer portion of the rubber ring is positioned on the second, outer ledge 414. The green rubber ring 600 has an inner side which is coated with a suitable adhesive as described below. The green rubber ring 600 is then cured over the flexible collar and affixed to the sidewall of the tire. The green rubber ring 600 may be cured by heat.

As shown in FIGS. 7 and 10, the filter housing major axis dimension and minor axis dimension is smaller than the pocket internal cavity 308, such that there is a gap surrounding the filter housing. The spatial gap can be in the range of 2 mm to about 8 mm.

In order to affix the filter assembly to the tire, the following steps are followed. First, the bottom and sides of the filter housing are buffed with abrasive material such as sandpaper. Next the bottom and sides of the filter housing are pretreated with Chemlock or other suitable adhesive. Preferably, the filter housing is placed in a mold and rubber is injection molded to enrobe the housing bottom and sides of the filter housing with rubber or elastomer. See FIGS. 13-15 which illustrate the enrobed filter housing 900 with a coating 902 of green rubber or elastomer. The type of rubber suitable for use is known to those skilled in the art as cushion gum, however any type of rubber would work. The coating of rubber 902 may be cured or partially cured about the housing.

Next, the pocket bottom surface 402 is buffed. As shown in FIG. 6, a green rubber patch 1000 is used to secure the filter housing to the tire pocket bottom surface. The green rubber patch 1000 is buffed on both sides. The rubber patch 1000 is then coated with a suitable adhesive on both sides and then inserted onto the pocket bottom surface. The patch 1000 preferably has a hole 1002 that is aligned with hole 402 of pocket. One suitable adhesive is Fast Dry Self-vulcanizing Cement made by the Rubber Patch Company. The filter housing is then inserted onto the rubber patch 1000, ensuring the holes 1002, 402 and 312 are aligned. Preferably, the filter housing bottom 900 has a rubber coating 902 which is first buffed, and then affixed to the rubber patch 1000.

Alternatively, the pocket bottom surface 902 and filter housing bottom 402 may be coated with a suitable adhesive, eliminating the need to coat both sides of the patch with a suitable adhesive.

The filter housing bottom, patch and pocket and adhesive may then be heat cured or cured at room temperature.

The following steps are followed to mount the regulator device 200. First, the regulator mounting surface 203 and sides of the regulator are buffed with abrasive material such as sandpaper. Next the mounting surface 203 and sides of the regulator are pretreated with Chemlock or other suitable adhesive, ensuring the holes 708,202,710 are protected from the application of adhesive. Preferably, the regulator housing is placed in a mold and rubber is injection molded to enrobe the regulator mounting surface and sides with rubber or elastomer such as cushion gum, however any type of rubber would work. The coating of rubber may be cured or partially cured about the regulator housing.

Next, inner liner surface of the tire is buffed. Depending upon the weight of the regulator, the inner tire surface may need to be buffed down to the ply. As shown in FIG. 6, a green rubber patch 1100 is used to secure the regulator to the tire pocket bottom surface. The green rubber patch 1100 is buffed on both sides. The rubber patch 1100 is then coated with a suitable adhesive on both sides and then inserted onto the inner surface of the tire. The patch 1100 preferably has holes 1102,1104,1106 that are aligned with holes 704,406,706 of tire. One suitable adhesive is Fast Dry Self-vulcanizing Cement made by the Rubber Patch Company. The Next, the regulator mounting surface is mounted over the rubber patch 1000, ensuring the holes 1102,1104,1106 are aligned with the regulator holes 708,202, 710 and with tire holes 704,406,706. The regulator is then cured to the tire with heat or room temperature cure, depending upon the adhesive selected.

Adjacent the pocket are two holes 704,706 as shown in FIG. 5. The holes 704,706 extend through the sidewall of the tire and are in fluid communication with aligned holes 708, 710 of the regulator. Pump tubes 702, 704 have a first end 703,705 that are inserted through holes 704,706 and into regulator holes 708,710. Pump tubes 702,704 preferably have quick connects on both ends such as barbs, etc. so that the system may be easily assembled. Pump tubes 702,704 are preferably made of high strength polyurethane. Pump tubes have a second end 712,714 that are bent about 90 degrees. The second ends 712,714 are connected to the pump ends 42a,42 and then inserted into slots 716,718 formed adjacent the pocket.

After the pump passageway is connected to the second ends 712,714 of the pump tubes, the pump passageway is inserted into channel 44. Preferably, the pump passageway is coated with rubber cement and then inserted into the pump passageway. A green cover strip of rubber having an inner surface is first coated with rubber cement and then is placed over the pump passageway in the annular channel. Heat may be used to cure the rubber cement.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An air maintenance tire and pump assembly comprising:
a tire having two spaced inextensible beads; a ground contacting tread portion; a pair of individual sidewalls extending radially inward from the axial outer edges of said tread portion to join the respective beads; a supporting carcass for the tread portion and sidewalls; an innerliner disposed radially inward of the carcass, the innerliner having a innerliner surface facing an interior cavity of the tire;
a pump passageway enclosed within a bending region of the tire, the pump passageway operatively closing and opening segment by segment as the bending region of the tire passes through a rolling tire footprint to pump air along the air passageway;
a regulator device in fluid communication with the pump passageway, the regulator device operable to regulate the fluid from outside of the tire into the pump passageway, the air inlet port assembly comprising a regulator assembly, the regulator device having a mounting surface coated with rubber;
the mounting surface adhered to the innerliner surface with a suitable adhesive.

2. A method for making an air maintenance tire and pump assembly, comprising the steps of :
a. Providing a green tire;
b. Molding a pocket in the sidewall of the tire, wherein the pocket has a hole extending though the side of the tire into the tire cavity;
c. Molding a groove in the sidewall of the tire;
d. Curing the tire;
e. Coating a green rubber patch on both sides with rubber cement and inserting the green rubber patch into the pocket;
f. Affixing a filter housing bottom to the green rubber patch;
g. Curing the green rubber patch;
h. Inserting a filter media into the filter housing;
i. securing a cover to the filter housing.

3. The method of claim 2 further comprising the steps of inserting a filter collar about the cover.

4. The method of claim 3 further comprising the steps of inserting a green rubber cover about the circumference of the filter collar, wherein the green rubber cover is coated with rubber cement, wherein the green rubber collar is cured.

5. The method of claim 4 further comprising the steps of molding a first and second hole through the tire on either side of the pocket, and then inserting a first and second pump tube through said holes.

6. The method of claim 5 further comprising the steps of connecting a first pump end and a second pump end to said first and second pump tubes.

7. The method of claim 6 further comprising the step of inserting the pump into the groove.

8. The method of claim 2 further including the following steps:
a. Buffing an inside surface of the cured tire,
b. Coating a green rubber patch on both sides with rubber cement and inserting the green rubber patch onto the buffed inside surface of the tire;
c. Affixing a mounting surface of a regulator to the green rubber patch;
d. Curing the green rubber patch.
